(19) United States
(12) Patent Application Publication
(10) Pub. No.: US 2026/0251361 A1
(43) Pub. Date: Aug. 27, 2026

(54) CARTRIDGE-REPLACEABLE MAGNETIC COOLING SYSTEM

(71) Applicant: KOREA INSTITUTE OF MATERIALS SCIENCE, Gyeongsangnam-do (KR)

(72) Inventors: Jong Woo KIM, Gyeongsangnam-do (KR); Ki Hoon KANG, Gyeongsangnam-do (KR); A Young LEE, Seoul (KR)

(73) Assignee: KOREA INSTITUTE OF MATERIALS SCIENCE, Gyeongsangnam-do (KR)

(21) Appl. No.: 18/992,426

(22) PCT Filed: Dec. 28, 2022
(86) PCT No.: PCT/KR2022/021485

§ 371 Date: Jan. 8, 2025

(30) Foreign Application Priority Data
Jul. 15, 2022 (KR) 10-2022-0087519

(51) Int. Cl. F25B 21/00

(52) U.S. Cl. CPC F25B 21/00; F25B 2321/0021

(57) ABSTRACT

The present disclosure is intended to solve the above-mentioned problems, relates to a cartridge replaceable magnetic cooling system expanding an operating temperature and selectively performing cooling/heating by forming a plurality of cartridges using magnetocaloric materials (MCM) with different temperature ranges and selectively replacing any one of a plurality of cartridges according to the intended use.

### TECHNICAL FIELD

The present disclosure relates to a cartridge replaceable magnetic cooling system capable of expanding an operating temperature by selectively applying magnetocaloric materials with different temperature ranges.

### BACKGROUND ART

Recently, due to international greenhouse gas (GHG) emission regulations and an increase in energy consumption related to cooling/refrigeration, there is a growing need to replace gas refrigerants (chlorofluorocarbons (CFCs)) in the existing gas compression cooling systems. Accordingly, researches on next-generation cooling systems are receiving much attention.

For example, a magnetic cooling system using a magnetocaloric effect (MCE) has the advantages of high energy efficiency and semi-permanence compared to gas compression cooling. In particular, a magnetic cooling method may be environmentally friendly because it does not use the gas refrigerants such as chlorofluorocarbons (CFCs), and implement noiseless and vibration-free.

Specifically, a magnetic cooling system using magnetocaloric materials (MCMs) uses the principle that a temperature of a material is heated/cooled by an entropy change that occurs according to an externally applied magnetic field.

The magnetic cooling system using these magnetocaloric (MCMs) may be applied to a household air conditioning materials system, a refrigerator, an air conditioning system of a data center server room, etc.

However, as illustrated in FIG. 1, an adiabatic temperature change (ATad), which is a characteristic of the magnetocaloric effect (MCE) that occurs according to the applied magnetic field in the magnetocaloric materials (MCM), forms a sharp peak only in a characteristic temperature range depending on a base temperature. Accordingly, there is a disadvantage in that the magnetic cooling system has a very narrow operating temperature range.

### DISCLOSURE

### Technical Problem

The present disclosure relates to a cartridge replaceable magnetic cooling system capable of expanding an operating temperature and selectively performing cooling/heating by forming a plurality of cartridges using magnetocaloric materials (MCM) with different temperature ranges and selectively replacing any one of a plurality of cartridges according to the intended use.

### Technical Solution

In view of the above, one embodiment of the present disclosure provides a cartridge replaceable magnetic cooling system, including: a main body case; a magnetic transfer unit that is replaceably coupled within the main body case and receives magnetocaloric materials so that heat is exchanged with a heat transfer fluid passing through the inside through an inlet on one side and an outlet on the other side; and magnetic field applying units that are disposed spaced apart from each other on front and rear sides of the main body case and selectively applies a magnetic field to the magnetocaloric materials, in which the magnetic transfer unit forms a plurality using of cartridges the magnetocaloric materials having different temperature ranges, and selectively couples one of the plurality of cartridges to the main body case according to the intended use to expand an operating temperature.

The main body case may include: a first holder that fixes the front and rear sides of the cartridge; and a second holder that fixes left and right sides of the cartridge equipped with the inlet and the outlet, and is connected to the inlet 123 and the outlet 125 so as to be in communication with each other and forms a path for the heat transfer fluid.

A sealing member may be interposed in a coupling portion of the second holder so as to improve watertightness performance.

The plurality of cartridges may include: an A type cartridge applied to an operating temperature of 0 to 10° C.; a B type cartridge applied to the operating temperature of 10 to 40° C.; and a C type cartridge applied to the operating temperature of 40 to 60° C.

The B type cartridge may be used as a four-season household air conditioner that performs cooling/heating as needed by being replaced with a cartridge type according to an operating temperature range.

The plurality of cartridges may be automatically replaced by an operation of an actuator according to an untended use that is disposed spaced apart on a conveyor that receives power and reciprocally moving by a predetermined distance or a rotating plate that rotates around a rotating axis.

The magnetic cooling system may further include a controller that measures an internal temperature of the magnetic transfer unit in real time and automatically replaces the cartridge receiving the magnetocaloric materials having a temperature range that matches a temperature range appropriate for user's desired temperature setting.

### Advantageous Effects

In the cartridge replaceable magnetic cooling system according to the present disclosure having the configuration described above, the plurality of cartridges can be formed using the magnetocaloric materials (MCMs) with different temperature ranges, and one of the plurality of cartridges with high energy efficiency can be selectively replaced and applied according to the operating temperature range, thereby expanding the operating temperature and selectively performing the cooling/heating. Accordingly, a single system can be used to achieve a certain level of energy efficiency for both heating and cooling in multiple temperature ranges.

### BRIEF DESCRIPTION OF DRAWINGS

FIG. 1 is a graph illustrating the characteristics of general magnetocaloric materials (MCMs).

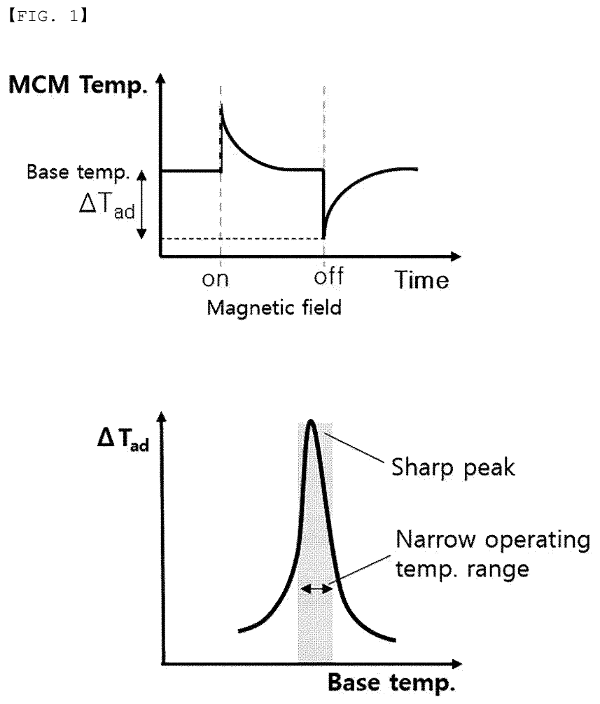

FIG. 2 is a plan view illustrating a schematic overall configuration of a cartridge replaceable magnetic cooling system according to the present disclosure,

FIGS. 3A to 3C are diagrams illustrating a plurality of cartridges according to the present disclosure.

FIG. 4 is an example of a use of the cartridge illustrated in FIG. 3 according to the operating temperature.

FIGS. 5 and 6 are diagrams illustrating specific types of magnetocaloric materials (MCMs) with different temperature ranges according to the present disclosure.

FIG. 7 is a plan view illustrating a device for automatically replacing a plurality of cartridges according to the present disclosure,

FIG. 8 is a side view of FIG. 7.

### MODE FOR INVENTION

Hereinafter, a configuration and an operation for a specific embodiment of the present disclosure will be described in detail with reference to the accompanying drawings.

Here, when adding reference signs to components of each drawing, it should be noted that the same components are indicated with the same signs as much as possible even if they are illustrated in different drawings.

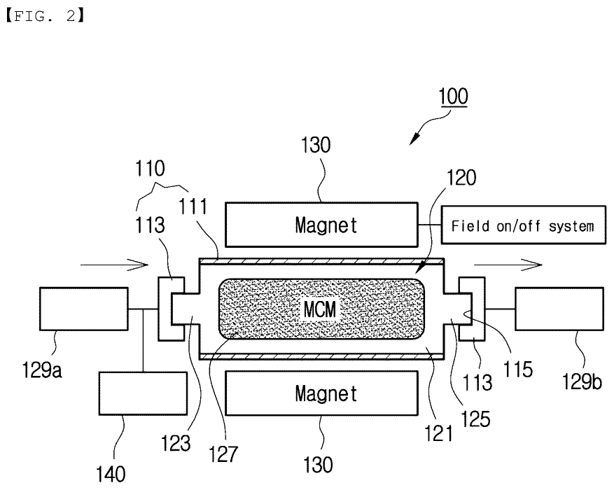

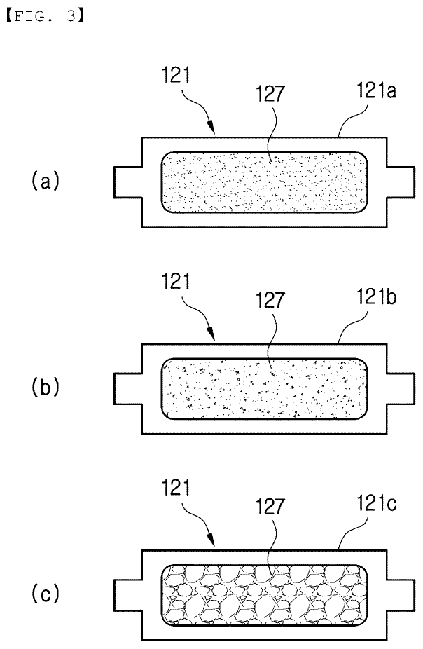

FIG. 2 is a plan view showing a schematic overall configuration of a cartridge replaceable magnetic cooling system according to the present disclosure, and FIGS. 3A to 3C are diagrams illustrating a plurality of cartridges according to the present disclosure.

Referring to FIG. 2, a cartridge replaceable magnetic cooling system 100 according to a preferred embodiment of the present disclosure may include a main body case 110, a magnetic transfer unit 120, and a magnetic field applying unit 130.

The configuration of the present disclosure will be described in detail below.

First, the main body case 110 constitutes a main case of the magnetic cooling system 100, and may have an internal receiving space with an opening so that the magnetic transfer unit 120 in the form of a cartridge 121, which will be described later, may be seated.

In this case, the main body case 110 may have a structure in which the cartridge 121 of the magnetic transfer unit 120, which will be described later, may be replaceably coupled.

Specifically, the main body case 110 may include a first holder 111 that fixes front and rear sides of the cartridge 121 when viewed in a plan view as illustrated in FIG. 2, and a second holder 113 that fixes left and right sides of the cartridge 121 equipped with an inlet 123 and an outlet 125, respectively, and is communicatively connected to the inlet 123 and the outlet 125 so as to be in communication with each other and forms a path for a heat transfer fluid introduced from heat transfer units 129a and 129b.

In addition, a sealing member 115 may be interposed at a coupling portion of the second holder 113 to improve watertightness performance. The material of the sealing member 115 in the present disclosure is not particularly limited.

The magnetocaloric materials 127 may be received inside the cartridge 121 of the magnetic transfer unit 120 so that they undergo a heat exchange process while the heat transfer fluid may be introduced into the inside through the inlet 123 and then discharged to the outside through the outlet 125.

Specifically, the cartridge 121 may be replaceably coupled inside the main body case 110. The cartridge 121 may have the inlet 123 provided on one side and the outlet 125 provided on the other side.

In this case, in FIG. 2 of the present disclosure, an example of a case where the inlet 123 is provided on one side of the cartridge 121 and the outlet 125 is provided on the other side is illustrated and described, but the inlet 123 and the outlet 125 may be changed in opposite directions depending on a flow direction of the heat transfer fluid.

That is, the magnetic transfer unit 120 may heat or cool the magnetocaloric materials 127 by the entropy change that occurs according to an externally applied magnetic field in the magnetic field applying unit 130 described later, and correspondingly, the flow direction of the heat transfer fluid may be changed from left to right (see the arrow in FIG. 2) or from right to left. The positions of the inlet 123 and the outlet 125 may be changed corresponding to the flow direction of the heat transfer fluid. The magnetic transfer unit 120 having the above configuration may be modularized into the plurality cartridges 121 using magnetocaloric materials having different temperature ranges. In addition, one of the plurality of cartridges 121 may be selectively replaced and coupled with the main body case 110 according to the intended use (refrigerator, four-season household air conditioner, server room air conditioner, etc.) desired by the user to expand the operating temperature.

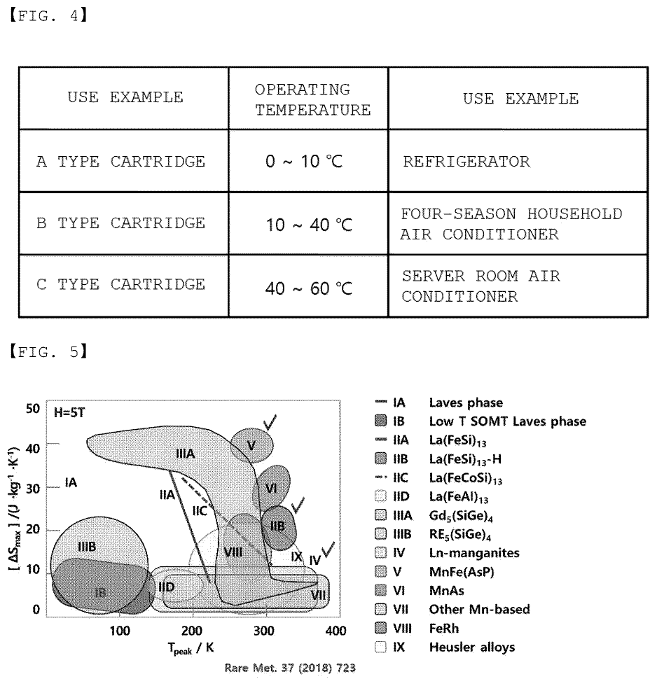

Specifically, referring to FIGS. 3 and 4, the cartridge 121 may include an A type cartridge 121a (for example, for a refrigerator) applicable to an operating temperature of 0 to 10° C., a B type cartridge 121b (for example, for a four-season household air conditioner) applicable to an operating temperature of 10 to 40° C., and a C type cartridge 121c (for example, for a server room air conditioner) applicable to an operating temperature of 40 to 60° C.

In particular, the B type cartridge 121b can be used in a room temperature range. Accordingly, the B type cartridge 121b can be used as the four-season household air conditioner capable of cooling/heating as needed by being replaced with a cartridge type according to the operating temperature range.

In this case, the present disclosure has been illustrated and described as an example of a case where three cartridges 121 are configured, but it is obvious that the number of cartridges 121 may be changed and applied to three or more as needed.

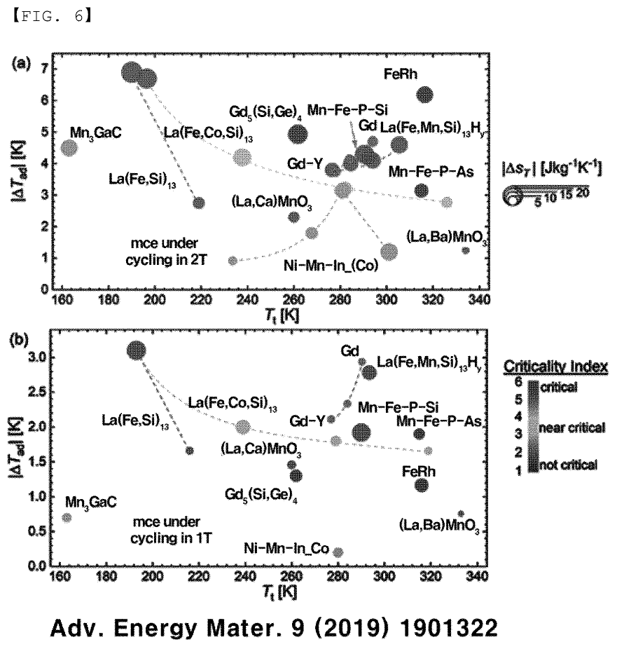

In addition, a specific type of magnetocaloric materials 127 applied to the plurality of cartridges 121a to 121c may be selectively applied and used by selecting a suitable material from among the plurality of materials as illustrated in FIGS. 5 and 6. Referring back to FIG. 2, the magnetic field applying unit 130 may selectively apply a magnetic field to the magnetocaloric materials 127 received in the magnetic transfer unit 120 by allowing permanent magnets (or electromagnets) to be disposed spaced apart from each other on front and rear sides of the main body case 110.

In this case, the magnetocaloric materials 127 may be heated/cooled according to the externally applied magnetic field, and may act as a coolant that absorbs and releases heat through heat exchange with a heat transfer medium of the heat transfer units 129a and 129b connected to the inlet 123 and the outlet 125 of the magnetic transfer unit 120. By utilizing this principle, one side may be cooled by giving directionality to heat movement. That is, the magnetic field applying unit 130 may perform heat transfer to a hot zone when heating the magnetocaloric materials 127 and to a cold zone when cooling the magnetocaloric materials 127 in a repetitive cycle by applying/removing the magnetic field using the permanent magnet. Accordingly, an internal temperature gradient of the magnetocaloric materials 127 may be formed, and it may be utilized as a cooling system with improved efficiency.

In addition, the magnetic cooling system 100 may include a controller 140 that controls a user to automatically replace and apply one of the plurality of cartridges 121 suitable for the intended use when the user's desired temperature is set. In this case, the magnetic transfer unit 120 may be equipped with a thermometer that measures the internal basic temperature, so the controller 140 may determine the selected temperature of the cartridge 121.

The controller 140 may store a type-specific and temperature-specific energy efficiency database magnetocaloric materials 127, and may set an optimal magnetic transfer unit 120 model for energy efficiency based on the database.

Meanwhile, the plurality of cartridges 121 may be replaced manually as needed, and may also be used by being replaced automatically.

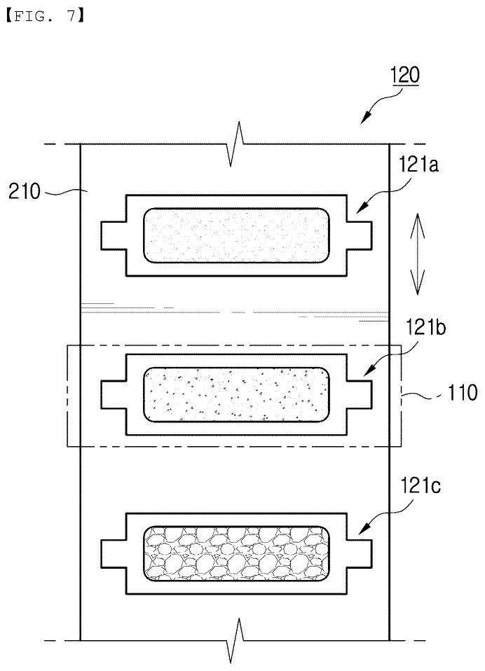

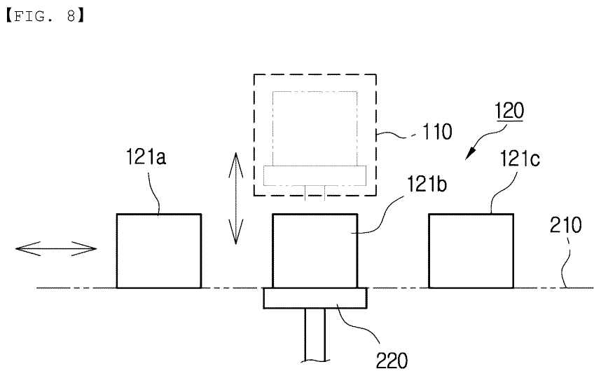

Specifically, referring to FIG. 7, the plurality of cartridges 121a to 121c may be disposed spaced apart from each other along a direction of movement on a conveyor 210 that receives power and reciprocally moves by a predetermined distance. As illustrated in FIG. 8, an actuator 220 may be provided on a lower side of a conveyor 210 to raise one of the plurality of cartridges 121a to 121c to the upper main body case 110 for replacement.

In this case, the conveyor 210 may be provided with a through hole so that one of the plurality of cartridges 121a to 121c may be raised using the actuator 220.

In another embodiment, the plurality of cartridges 121a to 121c may be applied in a changed manner in the case where they are radially disposed spaced apart by a predetermined angle on a rotating plate that receives power and rotates around a rotating axis instead of the conveyor 210.

According to the cartridge replaceable magnetic cooling system 100 of the present disclosure having the configuration described above, the plurality of cartridges 121a to 121c can be formed using the magnetocaloric materials (MCMs) with different temperature ranges, and one of the plurality of cartridges 121 with high energy efficiency can be selectively replaced and applied according to the operating temperature range, thereby expanding the operating temperature. Accordingly, a single system can be used to achieve a certain level of energy efficiency for both the heating and cooling in multiple temperature ranges.

Hereinabove, the present disclosure is illustrated and described with reference to a specific embodiment, but the present disclosure is not limited to the above-described embodiment, and various changes and modifications may be made without departing from the technical idea of the present disclosure.

[Reference Numeral]

| | |
|---|---|
| 100: Magnetic cooling system | 110: Main Body case |
| 111: First holder | 113: Second holder |
| 115: Sealing member | 120: Magnetic transfer |
| | unit |
| 121: Cartridge | 121a: A type cartridge |
| 121b: B type cartridge | 121c: C type cartridge |
| 123: Inlet | 125: Outlet |
| 127: Magnetocaloric materials | 129a, 129b: Heat transfer |
| | unit |
| 130: Magnetic applying unit | 140: Controller |
| 210: Conveyor | 220: Actuator |

1. A cartridge replaceable magnetic cooling system, comprising:
a main body case;
a magnetic transfer unit that is replaceably coupled within the main body case and receives magnetocaloric materials so that heat is exchanged with a heat transfer fluid passing through the inside through an inlet on one side and an outlet on the other side; and
magnetic field applying units that are disposed spaced apart from each other on front and rear sides of the main body case and selectively applies a magnetic field to the magnetocaloric materials,
wherein the magnetic transfer unit forms a plurality of cartridges using the magnetocaloric materials having different temperature ranges, and selectively couples one of the plurality of cartridges to the main body case according to the intended use to expand an operating temperature.

2. The cartridge replaceable magnetic cooling system of claim 1, wherein the main body case includes:
a first holder that fixes the front and rear sides of the cartridge; and
a second holder that fixes left and right sides of the cartridge equipped with the inlet and the outlet, and is connected to the inlet 123 and the outlet 125 so as to be in communication with each other and forms a path for the heat transfer fluid.

3. The cartridge replaceable magnetic cooling system of claim 2, wherein a sealing member is interposed in a coupling portion of the second holder so as to improve watertightness performance.

4. The cartridge replaceable magnetic cooling system of claim 1, wherein the plurality of cartridges include:
an A type cartridge applied to an operating temperature of 0 to 10° C.;
a B type cartridge applied to the operating temperature of 10 to 40° C.; and
a C type cartridge applied to the operating temperature of 40 to 60° C.

5. The cartridge replaceable magnetic cooling system of claim 4, wherein the B type cartridge is used as a four-season household air conditioner that performs cooling/heating as needed by being replaced with a cartridge type according to an operating temperature range.

6. The cartridge replaceable magnetic cooling system of claim 4, wherein the plurality of cartridges are automatically replaced by an operation of an actuator according to an untended use that is disposed spaced apart on a conveyor that receives power and reciprocally moving by a predetermined distance or a rotating plate that rotates around a rotating axis.

7. The cartridge replaceable magnetic cooling system of claim 1, wherein the magnetic cooling system further includes a controller that measures an internal temperature of the magnetic transfer unit in real time and automatically replaces the cartridge receiving the magnetocaloric materials having a temperature range that matches a temperature range appropriate for user's desired temperature setting.
